(19) United States
(12) Patent Application Publication
(10) Pub. No.: US 2021/0394720 A1
(43) Pub. Date: Dec. 23, 2021

(54) PALLET TRUCK STOPPER

(71) Applicant: Zrii Technologies, Inc., North York (CA)

(72) Inventor: Varouj Shahbazian, Montreal (CA)

(21) Appl. No.: 17/330,198

(22) Filed: May 25, 2021

Related U.S. Application Data
(60) Provisional application No. 63/040,842, filed on Jun. 18, 2020.

(51) Int. Cl. B60T 3/00

(52) U.S. Cl. CPC B60T 3/00

(57) ABSTRACT

A light, hand-held, generally block U-shaped rubberized stopper for manually-operated, wheeled hand trucks or pallet trucks. The stopper is placed on the floor surface and is guided, by the operator's hand or foot, toward the front pivot wheel or wheels of the pallet truck, once the front wheels of the pallet truck have been rotated 90 degrees in either direction. The wheels fit into the open end of the block U-shaped stopper, and the stopper is pushed in so that the prongs and the closed bracket end of the stopper enclose the front wheels of the pallet truck, in order to prevent movement and “park” the pallet truck in place. The distance between the prongs, and the stiffness or resistance of the prongs, are designed to grip the wheels of the pallet truck when in use and lock them in place, preventing movement. Additionally, each prong of the stopper has one or more raised ramp or wedge features on its top face that act to cradle the pivot wheels of the pallet truck when in their locked position, further restraining their movement. The stopper has a tab or handle that allows it to be hung from the handle of the hand truck, or on a wall or in a cabinet, when not in use. The stopper is constructed of light, durable, portable, PVC-grade moulded rubber, with a corrugated or sandblasted underside surface to further prevent movement of the stopper when in use. The stopper's construction meets all environmental and safety requirements, and is structurally able to withstand repeated use under a wide range of environmental conditions.

### PRIORITY CLAIM

The present application claims priority to U.S. Provisional Patent Application No. 63/040,842, filed Jun. 18, 2020.

### FIELD

The subject disclosure generally relates to light, moveable stoppers for widely-used, manually-operated hand trucks or pallet trucks, such as those commonly found in warehouse, shipping and receiving, and other like facilities for portable material handling. A light, hand-held, generally U-shaped rubberized stopper to be placed in a manner that encloses the front wheels of the pallet truck, in order to prevent movement and “park” the pallet truck in place, is provided.

### BACKGROUND

Goods are often stored or transported in in bulk quantities on wooden pallets, to facilitate their movement and protect them from damage. Pallets serve to elevate the bulk materials several inches above the warehouse floor, freight train car, or truck bed; they also facilitate ease of movement, loading and unloading, by warehouse personnel or other material handlers using devices known as pallet trucks. Pallet trucks resemble hand-operated forklifts, usually employing two heavy, metal, horizontal tines with metal rollers on their bottom side. These tines are usually connected at one end by a heavy metal bracket that houses a hydraulic pump connected to a vertical metal stanchion with hand controls on its upper end, and a supporting pivot wheel or wheels at its bottom.

The pallet truck operator manually moves materials by inserting the tines of the truck into the open space created by the pallets, beneath any loaded materials. The operator then elevates or “jacks” the pallets with their materials above the supporting surface. Once elevated, the pallet and materials are easily movable by the operator, primarily using the truck's supporting pivot wheel or wheels. The sturdy metal structure and powerful hydraulic pump of the pallet truck allows a single operator to move many hundreds or thousands of pounds of materials, which reduces the need for additional personnel to assist with loading and unloading in warehouses, and shipping and receiving facilities.

However, the metal structure and pump mechanism of the pallet truck results in an equipment weight of several hundred pounds, even when unloaded. In addition, whether unloaded or loaded, if not restrained by the operator or by the placement of surrounding material, a pallet truck tends to move along its bottom rollers and pivot wheel or wheels if the surface where the truck is located becomes unstable (as in a cargo vehicle or rail car), or if the truck is placed in an area with a sloped surface. If adequate precautions are not taken to restrain the movement of an untended pallet truck, its uncontrolled movement may cause property damage or personal injury.

One manner in which the movement of an unused pallet truck may be restrained is to restrict and immobilize the movement of its pivot wheel or wheels, effectively restraining the movement of the truck and “parking” it. Restricting and immobilizing the movement of the pivot wheel or wheels at the structural base of the truck generally immobilizes and restrains further movement of the entire device, even when the supporting surface is unstable or sloping.

A number of devices have been proposed for restraining the movement of pallet trucks. U.S. Pat. No. 5,839,863 to Johansson discloses a parking device for immobilizing a hand truck on the floor of a delivery truck or other cargo vehicle during the vehicle's movement. The parking device consists of a two-part frame, where the first part is longer and thicker than the other part, and is ramped on one side in order to facilitate the rolling of a hand truck into the frame. The second part of this device is a rectangular cradle or cavity for restraining the wheels of the hand truck. The undersurface of the parking device is coated with a high-friction coating material, or has feet similarly coated to prevent slipping relative to the floor of the vehicle.

U.S. Pat. No. 3,391,760 to Gonser discloses a similar device in which a steel wheel lock block is used to restrain the movement of the wheel of an automobile. This sheet steel device is generally in the shape of a rectangle, with beveled sides that permit a wheel of the automobile to be rolled up and then down into the interior restraining space. U.S. Des. Pat. No. 389,796 to Olson, discloses a long and shallow ramped platform and elevated, rectangular wheel restraint mechanism.

Wheel restraining devices are commonly seen in aviation settings, to prevent the further movement of aircraft once in a “parked” position; these devices are often called aircraft chocks. U.S. Des. Pat. No. 444,441 discloses a disk-shaped wheel chock with a ramped perimeter that rises to a certain height and then slopes downward to an interior space into which a wheel is moved, and thus restrained.

Other patents showing devices for restraining the movement of heavy wheeled devices by restricting the movement of their supporting wheels U.S. Pat. No. 2,870,872 to Rapp, disclosing a skid-resistant moldable automobile wheel chock; U.S. Pat. No. 4,911,270 to Hudson, disclosing a rigid chock for preventing the rolling movement of a vehicle wheel; and U.S. Pat. No. 5,046,587 to Jones, disclosing a trailer tongue wheel chock and support.

However, drawbacks and limitations exist in numerous of the wheel restraining mechanisms currently known and available. Many are difficult to maneuver the truck into, as they require the pallet truck to be pushed up a ramp or other frame edge, which can often be heavy and require significant exertion, causing them to be used less frequently than desired. If the pivot wheels slip or fail to mount the ramp or frame edge, the pallet truck can become destabilized, and its resulting uncontrolled movement can dislodge the pallet or the material thereon, causing accidents or damage. Other devices are heavy, cumbersome and difficult to lift, place, reposition and remove, and cannot be easily deployed; they also may create worker safety concerns.

While the usefulness of known and available pallet truck stopping devices is well-known, improvements and alternatives are generally desired. It is therefore an object to provide a novel pallet truck stopper solving the aforementioned problems, with a simplified, lightweight, easily deployed design.

### SUMMARY

It should be appreciated that this summary is provided to introduce a selection of concepts in a simplified form that are further described below in the detailed description of embodiments. This summary is not intended to be used to limit the scope of the claimed subject matter.

Accordingly, in one aspect there is provided a light, hand-held, generally block U-shaped rubber stopper device, with a design featuring two prongs and a bracket end, with the other end being open and unbracketed. The stopper has different faces on its top side and its bottom side. When a pallet truck operator wishes to “park” the truck and immobilize the wheels thereof, the operator pivots the front wheel or wheels of the truck 90 degrees in either direction, perpendicular to the truck, places the stopper on the floor surface and guides the stopper, using his or her hands or feet, toward the front pivot wheel or wheels of the pallet truck, with the open end of the stopper facing the truck wheels. The wheel or wheels fit into the open end of the stopper, and the stopper is pushed in so that the prongs and the closed bracket end of the stopper enclose the wheel set of the truck, immobilizing the wheel or wheels and restricting the truck's further movement.

In one or more embodiments, the stopper is constructed of light, durable, portable, PVC-grade moulded rubber, with a corrugated or sandblasted bottom surface to further prevent movement of the stopper when in use.

In one or more embodiments, each prong of the stopper has one or more raised ramp or wedge features on its top face, that act to cradle the pivot wheel or wheels of the pallet truck when in their locked position, further restraining their movement.

In one or more embodiments, the distance between the stopper prongs, and the stiffness or resistance of the prongs, are designed to grip the wheel or wheels of the pallet truck when in use and lock them in place, preventing further movement.

In one or more embodiments, the ratio of the length of the prongs to the span of the bracket end of the stopper is generally 2:1.

In one or more embodiments, the thickness of the prongs at their outer edge is thicker than at their inner edge, to assist in the ease of deployment of the stopper, and to further increase the restrictive action of the prongs on the pallet truck wheels.

In one or more embodiments, the stopper has a tab or handle that allows it to be hung from the handle of the pallet truck, or on a wall or in a cabinet, when not in use.

### BRIEF DESCRIPTION OF THE DRAWINGS

Embodiments will now be described more fully with reference to the accompanying drawings, in which:

FIG. 1 is a simplified underneath view of the pallet truck stopper, shown with corrugated bottom face, and with hanging tab or handle;

FIG. 2 is a simplified top view of the pallet truck stopper, shown with prongs, and raised ramp or wedge features mounted on each prong;

FIG. 3 is a a perspective schematic of the preferred embodiment of the pallet truck stopper, deployed on a floor or other like surface, engaging with the front pivot wheels of a pallet truck, where the front wheels of the pallet truck are shown fitting into the open end of the stopper, and the stopper pushed axially inward so that the prongs and the closed end of the stopper fully enclose the front wheels of the pallet truck, with the raised ramp or wedge features on the top face of the stopper prongs cradling the wheels to restrain their movement; and

FIG. 4 is a side view of the pallet truck stopper, shown resting on a flat surface.

FIGS. 5a and 5b show perspective top face and bottom face views of the pallet truck stopper.

### DETAILED DESCRIPTION OF EMBODIMENTS

The foregoing summary, as well as the following detailed description of certain embodiments, will be better understood when read in conjunction with the accompanying drawings. As used herein, an element or feature recited in the singular and preceded by the word “a” or “an” should be understood as not necessarily excluding a plural of the elements or features. Further, references to “one example” or “one embodiment” are not intended to be interpreted as excluding the existence of additional examples or embodiments that also incorporate the recited elements or features of that one example or one embodiment. Moreover, unless explicitly stated to the contrary, examples or embodiments “comprising,” “having” or “including” an element or feature or a plurality of elements or features having a particular property may further include additional elements or features not having that particular property. Also, it will be appreciated that the terms “comprises,” “has” and “includes” mean “including but not limited to” and the terms “comprising,” “having” and “including” have equivalent meanings.

As used herein, the term “and/or” can include any and all combinations of one or more of the associated listed elements or features.

It will be understood that when an element or feature is referred to as being “on,” “attached” to, “connected” to, “coupled” with, “engaged” with, “contacting,” etc. another element or feature, that element or feature can be directly on, attached to, connected to, coupled with, engaged with or contacting the other element or feature or intervening elements may also be present. In contrast, when an element or feature is referred to as being, for example, “directly on,” “directly attached” to, “directly connected” to, “directly coupled” with, “directly engaged” with or “directly contacting” another element of feature, there are no intervening elements or features present.

It will be understood that spatially relative terms, such as “under,” “below,” “lower,” “over,” “above,” “upper,” “front,” “back” and the like, may be used herein for ease of describing the relationship of an element or feature to another element or feature as depicted in the figures. The spatially relative terms can, however, encompass different orientations in use or operation in addition to the orientation depicted in the figures.

Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art.

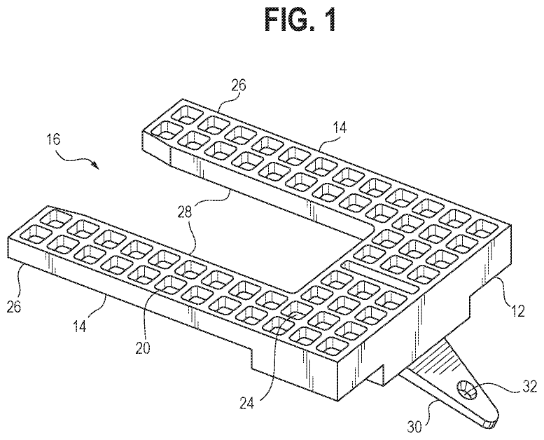

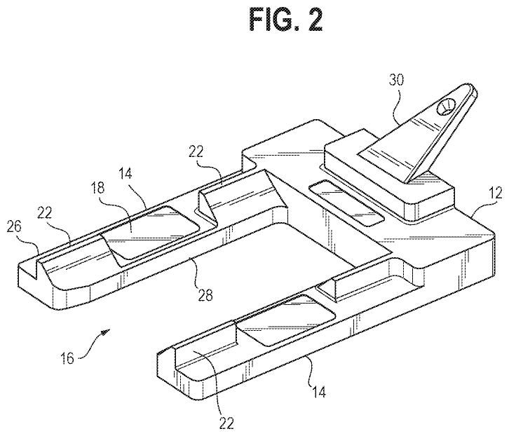

As shown in FIGS. 1-2, the pallet truck stopper 10 is a block U-shaped formed piece fabricated of light, durable, portable polyvinyl chloride, rubber, or such other materiel as may be determined by one skilled in the art. The PVC or rubber component may be recycled material. The pallet truck stopper is disposed with a closed, bracketed end 12 and two prongs 14, together comprising a block U-shape, with the end 16 opposite the bracketed end being open and unconnected. The ratio of the length of the prongs 14 to the span of the bracket end 12 is generally 2:1. The stopper 10 is generally light and is designed to be hand-held.

The pallet truck stopper 10 has different top 18 and bottom 20 faces. When disposed in its normal resting position on a flat surface, the top face 18 of the bracketed stopper end 12 has a raised thickness designed to give the stopper sufficient weight and maneuverability in deployment. The top face 18 of each of the prongs 14 may have one or more raised ramp or wedge features 22 thereupon. The bottom face 20 of the stopper is undifferentiated as between the prongs 14 and the bracketed stopper end 12. The bottom face 20 may have a corrugated or sandblasted surface texture 24.

The distance between the prongs 14 of the stopper, although generally determined by the span of the bracketed stopper end 12, and therefore by the size of the stopper, is generally designed to grip the wheel of wheels of pallet trucks, and will therefore generally conform to the dimensions of pallet truck pivot wheel sets. The stopper may nevertheless be designed in different sizes and ratios, to correspond to the different sizes of pallet truck pivot wheel arrays in use, as may be the case.

Together with the distance between the prongs 14 of the stopper, the thickness of the prongs, and the stiffness or resistance of the material with which they are fabricated, are designed to enclose and restrain the wheel set of the intended pallet truck, locking the wheels in place and preventing further movement.

The material thickness of the stopper prongs 14 at their outer edge 26 is greater than at their inner edge 28. Thinner interior edges 26 enable ease of maneuverability when the stopper is being moved into place, and assist with the restrictive action of the prongs 14 once the stopper has been moved to its fully deployed position.

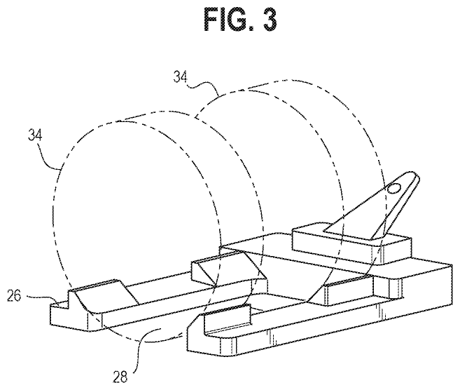

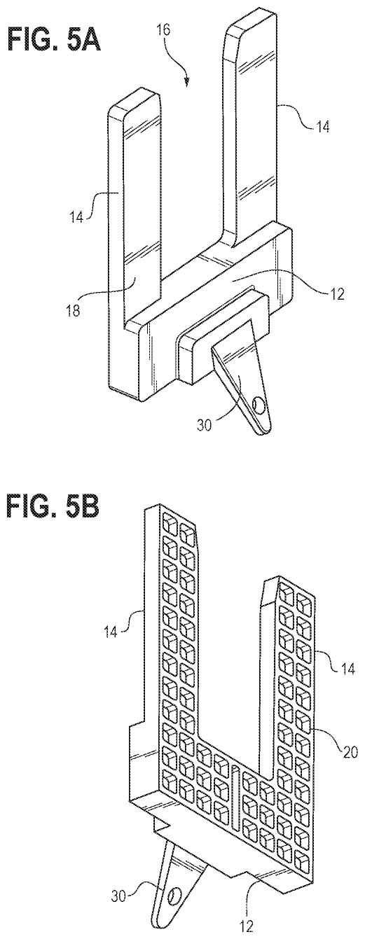

As shown by FIGS. 3-5, the stopper has a tab or handle 30 extending from the top face of its bracketed end, and may have features such as Velcro (not shown), or such as a hole 32, hook or indent to permit the stopper to be hung when not in use. The tab or handle will permit the stopper to be hung from the handle of the pallet truck, or on a wall or in a cabinet, or other like storage location.

In typical operation, the pallet truck stopper 10 is deployed by the operator when the pallet truck has been moved into a place and a position in which the operator desires it to remain. Once the truck has been so positioned, the operator manually pivots the truck's wheel 34 set 90 degrees in either direction, so that the wheel or wheels are perpendicular to the truck, i.e., perpendicular to the direction of the wheel in normal forward motion of the truck. The operator continues to manually restrain the truck from further movement while the stopper is deployed.

The operator lays or drops the stopper 10 onto the floor surface by hand, and then positions the stopper so that its open end 16 faces the truck's wheel set. The operator then pushes or slides the stopper, using either hand or foot, toward the wheel set, maneuvering the stopper so that one prong 14 is on either side of the wheel set. Typically, with the wheel set 34 pivoted perpendicular to the truck, and the operator facing the vehicle from a position generally at the front of the truck, at or near the truck stanchion and handle, the stopper 10 is maneuvered so that the open end 16 approaches the wheel set 34 from the wheel sides, as shown by FIG. 3. The wheel set 34 fits into the open end of the stopper, and each stopper prong encloses the wheel set from its respective side, and the operator continues to push or slide the stopper forward until the bracket end 12 of the stopper contacts the wheel set 34, and the stopper is fully engaged.

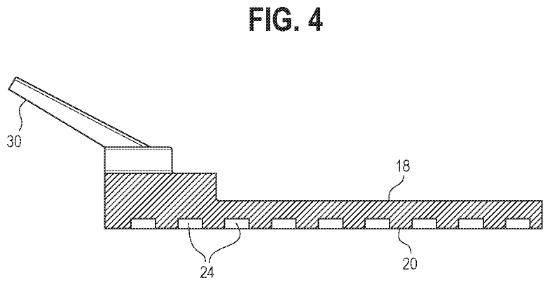

In the preferred embodiment illustrated in FIG. 3 of the accompanying drawings, the pallet truck stopper 10 is shown fully engaged with the pallet truck's wheel set 34, which have been pivoted so as to be perpendicular to the truck. The stopper prongs 14 and the bracket end 12 enclose the truck's wheel set on three sides, immobilizing the wheels and restraining further movement. The diminished thickness of the stopper prongs 14 on their interior side 28 confer ease of maneuverability as the stopper is moved into place by the operator. Once in its fully engaged position, the ramp or wedge features 22 on the top face 20 of the stopper prongs 14 create a cradle effect, further restraining any movement of the wheel set. The thickness differential between the interior 28 and the exterior edges 26 of the stopper prongs further contribute to the restrictive action. The corrugated or sandblasted texture 24 of the stopper's bottom surface (as shown in FIG. 4) prevent independent movement of the stopper itself, once deployed. In this preferred embodiment, the truck is now “parked”, and further movement of its wheel set is effectively prevented.

Once the operator desires to again operate the truck, the stopper 10 is easily removed by kicking or lifting out of its deployed position. As constructed, the stopper is sufficiently lightweight and manipulable such that removal is not difficult. In addition, the stopper may be constructed in a manner that meets all environmental and safety requirements, and in a manner that is structurally able to withstand repeated use under a wide range of environmental conditions.

Although embodiments have been described above and are shown in the accompanying drawings, it will be appreciated by those skilled in the art that variations and modifications may be made without departing from the scope as defined by the appended claims, and the scope of the claims should be given the broadest interpretation consistent with the specification as a whole.

What is claimed is:

1. A pallet truck stopper for controlling the movement of at least one wheel of a pallet truck comprising:
a. a bracketed end piece;
b. a pair of prongs formed at each end of the bracketed end piece so as to form a block U-shape thereby, each of the pair of prongs having an interior edge and an exterior edge, and each of the pair of prongs having a top face and a bottom face; and
c. at least one ramp formed on the top face of each of the pair of prongs.

2. The pallet truck stopper of claim 1, wherein each prong has a variable thickness such that each of the pair of prongs such that the interior edge of each prong is thinner than its corresponding exterior edge.

3. The pallet truck stopper of claim 1, wherein the bottom face of the pair of prongs has a corrugated surface.

4. The pallet truck stopper of claim 1, wherein the bracketed end piece defines a span, and the length of each of the pair of prongs is about twice the span of the bracketed end piece.

5. The pallet truck stopper of claim 1, further comprising a handle extending from the bracketed end piece opposite the pair of prongs.

6. The pallet truck stopper of claim 5 wherein the handle has an aperture for hanging the pallet truck stopper when not in use.

7. A pallet truck stopper for controlling the movement of at least one wheel of a pallet truck comprising:
a. a bracketed end piece;
b. a pair of prongs formed at each end of the bracketed end piece so as to form a block U-shape thereby, each of the pair of prongs having an interior edge and an exterior edge, and each of the pair of prongs having a top face and a bottom face; and
c. a variable thickness of each of the pair of prongs such that the interior edge of each prong is thinner than its corresponding exterior edge.

8. The pallet truck stopper of claim 7, further comprising at least one ramp formed on the top face of each of the pair of prongs.

9. The pallet truck stopper of claim 7, wherein the bottom face of the pair of prongs has a corrugated surface.

10. The pallet truck stopper of claim 7, wherein the bracketed end piece defines a span, and the length of each of the pair of prongs is about twice the span of the bracketed end piece.

11. The pallet truck stopper of claim 7, further comprising a handle extending from the bracketed end piece opposite the pair of prongs.

12. The pallet truck stopper of claim 11 wherein the handle has an aperture for hanging the pallet truck stopper when not in use.

13. The method of restraining the movement of a wheel set on a pallet truck comprising the steps of:
a. pivoting the wheel set so as to be perpendicular to the truck;
b. placing a block U shape stopper comprising a bracketed end piece and a pair of prongs, each of the pair of prongs having wedge feature formed thereon, such that the bracketed end piece contacts at least one wheel of the wheel set, the wedge features of the pair of prongs forming a cradle to further restrain any movement of the wheel set.
